(19) United States
(12) Patent Application Publication
(10) Pub. No.: US 2023/0351225 A1
(43) Pub. Date: Nov. 2, 2023

(54) MACHINE LEARNING-BASED USER SELECTION PREDICTION BASED ON SEQUENCE OF PRIOR USER SELECTIONS

(71) Applicant: Home Depot Product Authority, LLC, Atlanta, GA (US)

(72) Inventors: Walid Shalaby, Los Gatos, CA (US); Amir Hossein Afsharinejad, Atlanta, GA (US); Xiquan Cui, Brookhaven, GA (US); Sejoon Oh, Atlanta, GA (US)

(21) Appl. No.: 17/947,117

(22) Filed: Sep. 17, 2022

Related U.S. Application Data
(60) Provisional application No. 63/337,355, filed on May 2, 2022.

(51) Int. Cl. G06N 5/04; G06N 5/02

(52) U.S. Cl. CPC G06N 5/04; G06N 5/022

(57) ABSTRACT

A method for predicting a next user selection in an electronic user interface includes receiving, from a user, a sequence of selections of documents and generating, for each document in the sequence, a respective attribute vector. The attribute vector includes a numerical attribute vector portion representative of numerical attributes of the document, a category attribute vector portion representative of category information of the document, a text content vector portion representative of text content of the document, and an image content vector portion representative of an image in the document. The method further includes inputting the attribute vectors of the sequence into a machine learning model, and outputting, to the user, in response to the sequence of selections, a predicted next document selection according to an output of the machine learning model.

### TECHNICAL FIELD

This disclosure generally relates to prediction of a next user action in an electronic interface given a sequence of prior user actions, including a particular training approach for a machine learning model for such predictions.

### BACKGROUND

Predictions of website user behavior may be utilized in numerous ways. For example, a user's browsing sequence may be used to predict (and therefore recommend) the user's next desired browsing action. In another example, a user's purchase sequence may be used to predict (and therefore recommend) a next product for the user.

### BRIEF DESCRIPTION OF THE DRAWINGS

FIG. 1 is a diagrammatic view of an example system for providing a recommendation to a user based on a sequence of actions of the user.

FIG. 2 is a flow chart illustrating an example method for determining and outputting a predicted next user action in an electronic user interface.

FIG. 3 is a flow chart illustrating an example method of generating a document sequence representation.

FIG. 4 is a diagrammatic view of a system for determining a predicted next user action, including cold-start documents.

FIG. 5 is a diagrammatic view of a system for determining a predicted next user action.

FIG. 6 is a diagrammatic view of an example embodiment of a user computing environment.

### DETAILED DESCRIPTION

Known sequential recommendation systems do not adequately utilize substantive information about the subjects of user behavior (i.e., documents and their contents or subjects) in either training data or in live recommendations. A novel sequential recommendation system according to the present disclosure may improve upon known systems and methods by utilizing information about of the subject of documents, such as by training a machine learning model on such information, to generate more accurate predictions of a next user action.

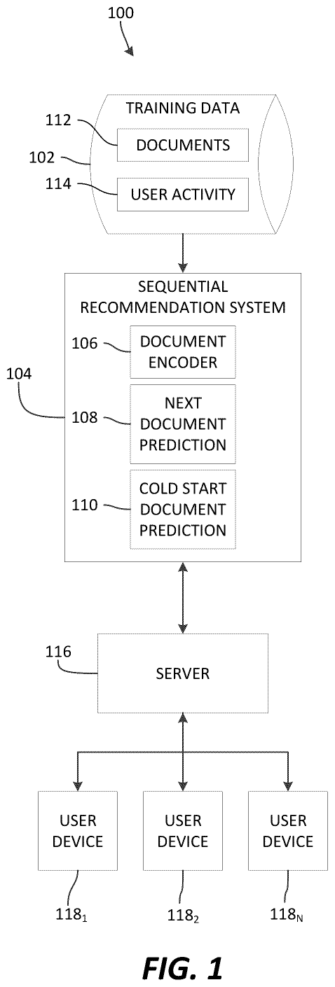

Referring now to the drawings, wherein like numerals refer to the same or similar features in the various views, FIG. 1 is a diagrammatic view of an example system 100 for providing a recommendation to a user based on a sequence of actions of the user. The system 100 may include a training data source 102 and a sequential recommendation system 104 that may include one or more functional modules 106, 108, 110 embodied in hardware and/or software. In an embodiment, the functional modules 106, 108, 110 of the sequential recommendation system 104 may be embodied in a processor and a memory (i.e., a non-transitory, computer-readable medium) storing instructions that, when executed by the processor, cause the system to perform the functionality of one or more of the functional modules and/or other functionality of this disclosure.

The training data source 102 may include a set of documents 112 and records of user activity 114. In some embodiments, the documents 112 may be documents specific to or otherwise accessible through a particular electronic user interface, such as a website or mobile application. The user activity 114 may be user activity on the electronic user interface, such as user navigations to the documents, user selections of the subjects of the documents, sequences of user selections of the documents, etc. For example, in some embodiments, the documents 112 may be respective of products and services offered through an e-commerce website (e.g., where each documents is respective of a given product or service), and the user activity 114 may be user interactions with the documents themselves (e.g., user navigations to, clicks on, or examinations of the documents), and/or user interactions with the products and services that are the subjects of those documents (e.g., purchases, additions to cart, etc.).

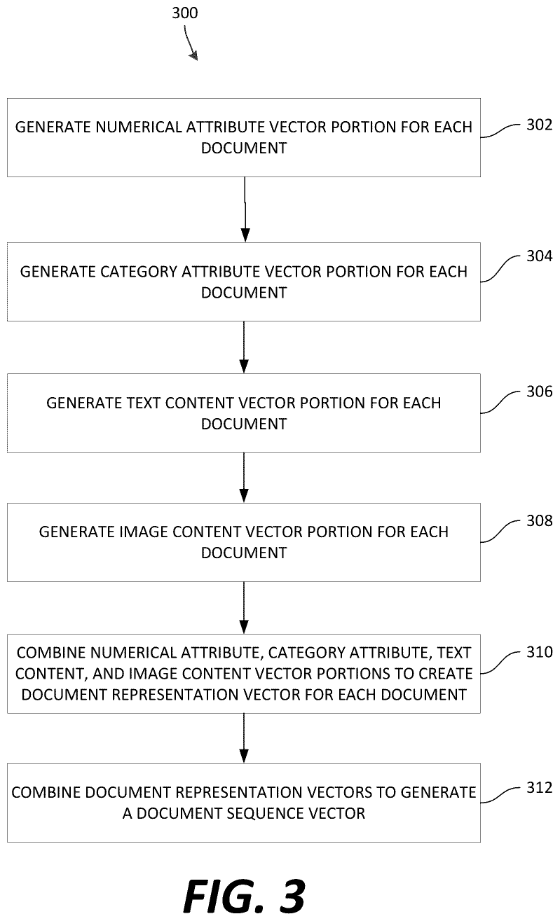

The functional modules 106, 108, 110 of the sequential recommendation system 104 may include a document encoder 106 that receives, as input, a document, and generates a representation of that document. The representation may be or may include one or more vectors representation of the metadata and/or contents of the document. Example operations for generating a document representation will be discussed in detail with respect to FIG. 3 below.

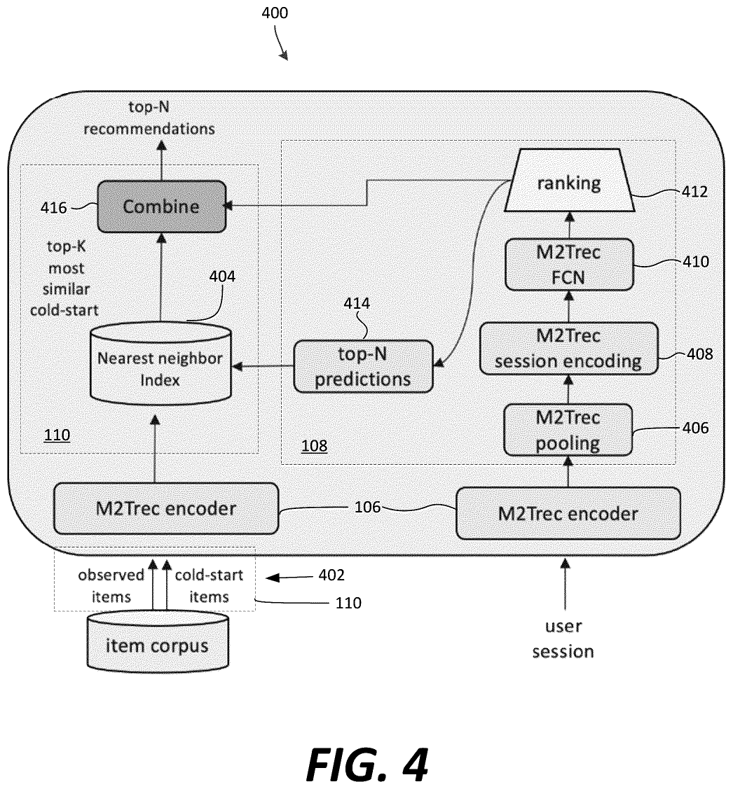

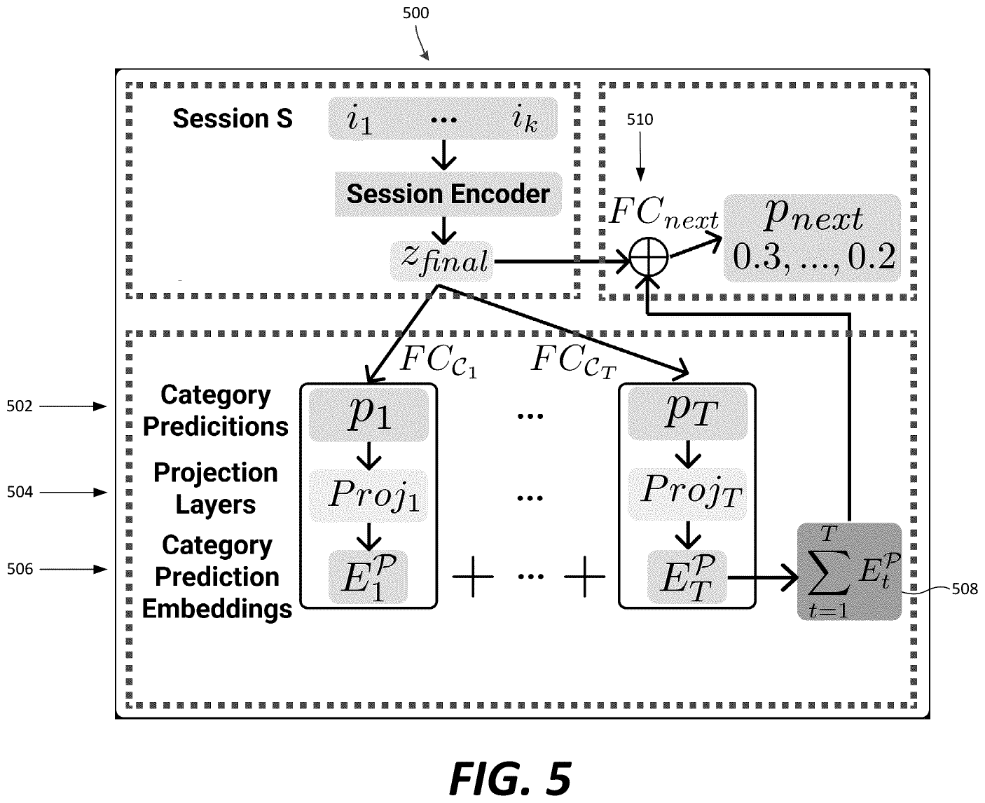

The functional modules 106, 108, 110 may further include a next document prediction module 108 that receives, as input, one or more document representations (e.g., a sequence of document representations, or a representation of a sequence of documents) and may output one or more predicted next documents, and/or one or more characteristics of one or more predicted next documents. The next document prediction module 108 may include one or more machine learning models or model portions. Example operations for predicting a next document will be discussed in detail with respect to FIGS. 4 and 5 below.

The functional modules 106, 108, 110 may further include a cold start document prediction module 110 that may predict cold-start documents—e.g., documents of which the next document prediction module is not aware. In some embodiments, the cold start document prediction module 110 may operate in conjunction with the next document prediction module 108 to include cold start documents in the one or more predicted next documents that may be output to a user, or considered for output to a user.

The sequential recommendation system 104 may be configured to train one or more machine learning models (e.g., one or more models included in the document encoder 106 and/or next document prediction module 108) using the training data 102. For example, in some embodiments, the training module 106 may train a machine learning module using the documents 112 to enable the model to recognize and predict sequences of user actions based on the metadata and contents of the documents 112 associated with those user actions.

The sequential recommendation system 104 may further be configured to use the trained machine learning model(s) to, given an input of a sequence of user actions, predict the most likely next user action (or multiple such actions). For example, the trained machine learning model may be applied in conjunction with a website to recommend a next document to a user based on that user's sequence of actions on the website. In some embodiments, the trained machine learning model may receive a sequence of products and/or services that a user interacts with, such as by viewing, adding to cart, or purchasing, and may output a predicted product or service, or the characteristics of a predicted product or service, based on that sequence.

The system 100 may further include a server 116 in electronic communication with the sequential recommendation system 104 and with a plurality of user computing devices 1181, 1182, . . . 118N. The server 116 may provide a website, data for a mobile application, or other interface through which the users of the user computing devices 118 may navigate and otherwise interact with the documents 112. In some embodiments, the server 116 may receive a sequence of user actions through the interface, provide the sequence of user actions to the sequential recommendation system 104, receive a next document prediction from the sequential recommendation system 104, and provide the next document prediction to the user (e.g., through the interface).

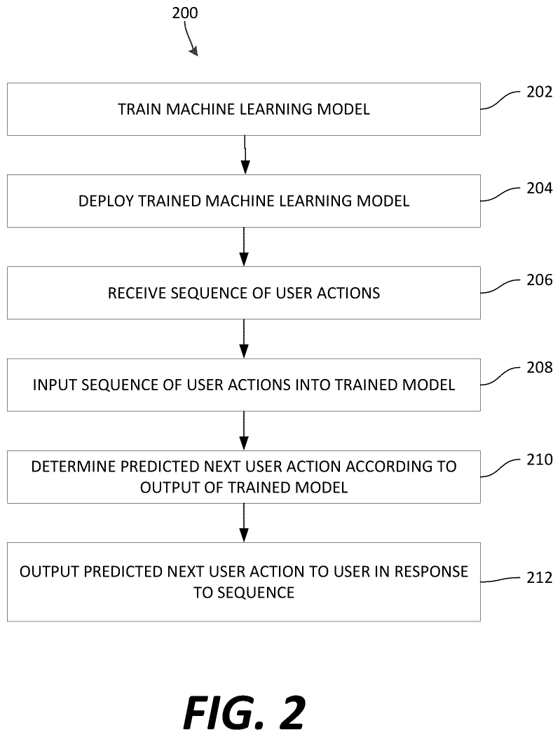

FIG. 2 is a flow chart illustrating an example method of providing a recommendation to a user based on a sequence of actions of the user. The method 200, or one or more portions of the method 200, may be performed by the system 100, and more particularly by the sequential recommendation system 104, in some embodiments.

The method 200 may include, at block 202, training a machine learning model. The machine learning model may be trained to receive, as input, a sequence of user actions and to output one or more predicted next user actions, or one or more characteristics of the predicted next user action(s). For example, in some embodiments, the machine learning model may be trained to accept a sequence of documents and to output one or more characteristics of a predicted next document. In a further example, the machine learning model may be trained to accept a sequence of products and/or services available on an e-commerce website and to output a predicted next product or service or one or more characteristics of a predicted next product or service.

Training the machine learning model at block 202 may be performed using a set of training data that may include, for example, documents accessible through a given interface, such as a website or mobile application. The documents may be, for example, individual web pages, information pages for respective products or services, spreadsheet or database rows, text lines, etc. The training data may further include user activity through the interface, such as interaction with the documents and/or their contents or subject, that occurred before training.

The method 200 may further include, at block 204, deploying the trained machine learning model. The trained machine learning model may be deployed in conjunction with a website or mobile application, such as the website or mobile application with which the training data is associated. After deployment, each user's sequence of actions on the interface may be analyzed according to the trained machine learning model, and output based on the trained machine learning model may be provided to the user through the interface.

The method 200 may further include, at block 206, receiving a sequence of user actions. The sequence of user actions may be a user's interactions with the interface with which the training data used at block 202 is associated. For example, the user actions may be a sequence of documents that the user selects (e.g., clicks), navigates to, scrolls, or the contents (e.g., products and/or services) of which documents the user purchases, adds to cart, etc.

The method 200 may further include, at block 208, inputting the sequence of user actions into the deployed trained model. In some embodiments, each new user action may be input to the trained model, such that the trained model is predicting a next user action in response to each new user action, based on the sequence of prior user actions. The sequence of user actions may be of a defined length, in some embodiments. For example, in some embodiments, up to three prior user actions, in sequence, may be input to the model. In another example, all user actions within a single browsing session, or within a given time frame (e.g., one day), may be input to the model. In another example, up to a predetermined number of user actions (e.g., up to 50 user actions) without an intervening gap between actions that is greater than a threshold (e.g., a gap of one day or more between user actions may result in a new sequence of user actions) may be input to the model.

In response to the input sequence of user actions, the machine learning model may output one or more predicted next user actions, or one or more characteristics of the predicted next user action(s). For example, the machine learning model may output one or more characteristics (e.g., a plurality of characteristics) of a predicted next document, such as one or more characteristics of a product or service that is the subject of the predicted next document. For example, in an embodiment in which the documents are respective of products and services, the machine learning model may output words (e.g., unique attributes) that describe a predicted next product or service. In another embodiment, the machine learning model may output a unique identifier respective of one or more predicted next documents.

The method 200 may further include, at block 210, determining a predicted next user action based on the output of the trained machine learning model. For example, in an embodiment in which the model outputs a unique identifier of a document as the predicted next user action, that document may be designated as the predicted next user action. In another example, in an embodiment in which the machine learning model outputs characteristics of a document, or of a product or service, block 210 may include determining the document, product, or service on the interface that is most similar to the characteristics output by the model. In a further example, where the model outputs embeddings, block 210 may include determining the document, product, or service having embeddings that are most similar to the embeddings output by the model.

In some embodiments, block 210 may include applying a nearest-neighbor algorithm to the model output to determine the closest available document, or product or service that is the subject of a document. For example, a nearest neighbor algorithm may be applied to words or other descriptors output by the model to find the most similar document or document subject. Additionally or alternatively, a cosine similarity function, hamming distance calculation, Levenshtein distance calculation, and/or another string-based or token-based similarity function may be applied to determine the most similar document embeddings to the model output embeddings.

In some embodiments, block 210 may include adding one or more cold-start document predictions to the predicted next actions output by the machine learning model. Such cold start documents may be documents on which the machine learning model was not trained, and therefore may not output (e.g., in embodiments in which the model outputs unique item identifiers). Cold start documents may be added based on their similarity to one or more documents predicted to be the next user action by the machine learning model, for example.

The method 200 may further include, at block 212, outputting the predicted next user action(s) to the user in response to the received sequence of user events. For example, the predicted next document, or product or service that is the subject of the predicted next document, may be output to the user in the form of a page recommendation, product recommendation, service recommendation, etc., through the electronic interface. In some embodiments, block 212 may include displaying a link to the predicted next document in response to a user search. In some embodiments, block 212 may include displaying a link to the predicted next document in response to a user navigation. In some embodiments, block 212 may include displaying a link to the predicted next document in response to a user click.

In some embodiments, blocks 206, 208, 210, and 212 may be performed continuously respective of a plurality of users of an electronic interface to provide next action predictions to each of those users, responsive to each user's own activity. In some embodiments, predictions may be provided to a given user multiple times during the user's browsing or use session, such that the prediction is re-determined for multiple successive user actions in a sequence.

FIG. 3 is a flow chart illustrating an example method 300 of generating a document sequence representation. The method 300, or more or more portions of the method 300, may be performed by the sequential recommendation system 104 (e.g., by the document encoder 106 and/or next document prediction module 108), in some embodiments. The method 300 may be performed with respect to a sequence of documents that have been selected by a user, for example.

We denote a user session S=[I1, I2, I3, . . . , In] as a sequence of items a user interacted within that session. Each item Ik={Ak,1, Ak,2, Ak,3, . . . , Ak,m} is described by a set of m attributes which could be context-specific (e.g., time since last interaction) or item-specific. In this work, we consider item-specific attributes only (e.g., title, description, category, price, etc). Each attribute A could be either textual, categorical, or numerical.

In the setting of session-based recommendations, we are given a session S, and our objective is to maximize the prediction probability of the next item the user is most likely to interact with given all previous items in S. Formally, the probability of the target item In can be formulated as shown in equation (1) below:

p(Iₙ|S_{[1<n]};θ) (Eq. 1)

where θ denotes the model parameters and S_{[1<n]} denotes the sequence of items prior to the target item Iₙ.

As in previous works [15, 21, 22, 56], we generate dense next-item sub-sequences from each session S for training and testing. Therefore, a sessionS withn items will be broken down in to n−1 sub-sequences such as {([I1], I2), ([I1, I2], I3), . . . , ([I1, 12, . . . , In−1], In)}, where ([X], Y) means X as the input sequence of items and Y as the target next item. Item metadata can be numerical (e.g., price), categorical (e.g., category), or unstructured such as title, description, image, etc. In this work, we propose a unified method for representing all item attributes. The objective is to map every attribute A into real-valued vector v_{A}∈R^{d}^{_{A}}.

The method 300 may include, at block 302, generating a respective numerical attribute vector portion for each document in the sequence of documents. In some embodiments, numerical attributes r may be represented as single valued vectors vᵣ∈R.

The method 300 may further include, at block 304, generating a respective category attribute vector portion for each document in the sequence of documents. For example, categorical attributes C∈{c₁, c₂, . . . , cₛ} may be encoded into vectors vc using an embedding layer dedicated to each attribute, such as described by equation 2 below:

v_{C}=cᵢθ^{(c)}∈R^{d}^{_{C}} (Eq. 2)

where cᵢ is the one-hot encoded value of C, θ^{(C)}∈R^{s×dC} are the weights of the category embedding matrix, s is the number of possible values of C, and dc is the dimensionality of C's vector.

The method 300 may further include, at block 306, generating a text content vector portion for each document in the sequence of documents. In some embodiments, textual attributes T may be first tokenized using a subword tokenizer to obtain individual tokens [w₁, w₂, . . . , wₜ] and then encoded into vectors v_{T}. For example, a simple and efficient encoding strategy may be employed by creating a dedicated embedding layer for T to map each token w into a vector and then aggregate the token vectors using mean or max pooling, as shown in equation (3) below:

v_{T}=Poolᵢ₌₁^{t}(wᵢθ^{(T)}∈R^{d}^{_{T}}) (Eq. 3)

where wᵢ is the one-hot encoded value of token wᵢ, wᵢθ^{(T)}∈R^{d}^{_{T}} are the weights of the token embedding matrix, k is the number of vocabulary tokens of T, and d_{T} is the dimensionality of T's vector.

While uniform pooling is computational efficient as applied above, it does not encode each token's complex context and gives equal importance to all the tokens. Accordingly, a more sophisticated encoding mechanism may be used to generate contextual embeddings of T's tokens using Bi-LSTM, auto-encoders, or pretrained sentence embedding models (e.g., BERT). For example, a vanilla Transformer encoder can be used to generate contextual embeddings of T's tokens and then VT may be obtained by pooling individual tokens' vectors, as shown in equation (4) below:

v_{T}=Poolᵢ₌₁^{t}((Trans−enc(wᵢ₌ₑ^{t};θ^{(enc}^{_{T}}⁾))∈R^{d}_{T}) (Eq. 4)

where θ^{(enc}^{_{T}}⁾ is the model parameters of the Transformer encoder for textual attributes T.

Further enhancements to textual attributes encoding can be achieved by sharing the encoding parameters across all textual attributes that have similar vocabularies such as item title, description, category, color, etc. A single dedicated embedding layer (Eq. (3)) or a single encoder (Eq. (4)) may be used. Although the weight sharing scheme may reduce the training time, it may increase the overall model size. This is because the vector size would be the same for all the attributes that share the same encoder regardless their vocabulary size. This will lead to high memory and storage requirements when deploying the model in production. Alternatively, a separate embedding layer for each textual attribute may be used as in Eq. (3) and a vector size proportional to the attribute's vocabulary size may be used.

The method 300 may further include, at block 308, generating an image content vector portion for each document in the sequence. An image content vector portion may be generated using image2vec or another tool for generating embeddings respective of one or more images. The image content vector portion may be representative of a single image in the document, or of multiple images in the document.

The method 300 may further include, at block 310, for each document, combining the numerical attribute vector portion, the category attribute vector portion, the text content vector portion, and the image content vector portion to create a respective document representation vector for the document. Block 310 may include, for example, concatenating the vector portions to create the document representation vector. By way of further explanation, after encoding all metadata features for an item Iₖ at position k in the input session S, the feature vectors of a document may be concatenated to create a compound vector representation v_{Ik} for Iₖ, as shown in equation (5) below:

v_{I}_{ₖ}concat(v_{A}_{₁},v_{A}_{₂}, . . . ,v_{A}_{ₘ})∈R^{d}^{_{I}} (Eq. 5)

where d_{I} is the summation of the lengths of all feature vectors. Notably, unique item identifiers (item-IDs) (e.g., unique identifiers of the documents or of an item represented in the document) are not used to create the compound representation v_{I}_{ₖ} in Equation (5), in some embodiments. An item-ID free approach may be more accurate for predicting cold-start items and may require less training time and computational resources, compared to the models utilizing item-IDs.

The method 300 may further include, at block 312, combining the document representation vectors to generate a document sequence vector. For example, the compound representations of individual items in S may be input to a session encoder in a pre-fusion fashion to learn a session encoding vs. First, the vanilla Transformer encoder referenced above may generate contextual encodings for each session item v_{I}_{ₖ}, followed by a pooling layer to generate the session encoding vs, as shown in equation (6) below:

v_{S}=Poolₖ₌₁ⁿ⁻¹((Trans−enc(v_{I}_{ₖ};θ^{(enc}^{_{S}}⁾))∈R^{d}^{_{S}}) (Eq. 6)

where θ^{(enc}^{_{S}}⁾ is the model parameters of the Transformer encoder trained with sessions S. For the pooling layer, diverse options may be used, such as max-pooling, trainable pooling, or average pooling. In some embodiments, an average-pooling layer may have the best prediction performance.

FIG. 4 is a diagrammatic view of a system 400 for determining a predicted next user action, including cold-start documents. The system 400 may be considered an embodiment of the system 100.

As noted above, in some embodiments, the document information used to generate document representations and session representations may lack unique item identifiers. As a result, cold-start documents that have similar attributes to observed ones may have similar representations (e.g., embeddings) when mapped into the same embedding space using the encoder 106. Moreover, the generated cold start document encodings may capture the dependencies across different attributes since the encoder may be fed with concatenated representations of individual attributes in pre-fusion fashion and may learn the optimal way to combine these attributes while being trained on the sequential session data.

Referring to FIG. 4, a method for including cold-start documents in next action predictions will be described. First, synthetic sessions, each session including a single document, using all documents (including cold-start ones) may be created at operation 402, and then input these sessions encoder 106 (after training) to obtain a vector representation for each document (e). Next, these vectors may be used to create a nearest neighbor index 404 containing the top-K similar cold-start items of each observed item along with their similarity score. The score Sim_{o,c} can be computed using cosine similarity between eₒ and e_{c} of an observed document o and a cold-start document c, respectively. As new documents are added to the set for consideration in predictions, synthetic sessions may be created only for these items and the nearest neighbor index can be updated incrementally with new items' similarities to observed ones without the need to retrain the model. Next, at serving/deployment time, the input session is input to the document encoder 106 and to the next document prediction module 108 to determine a top-N item-IDs at 414 from the observed items along with their probabilities (Probₒ for item o). Next, the top-K similar cold-start items for each of the top-N items may be determined using the inverted index. A concatenated list of observed and cold-start items may be ranked and combined at 416 based on their score such that: (1) observed items have their scores equal to the their probabilities from the next document prediction module; and (2) each cold-start item c has its score computed according to equation (7) below:

$${arg max}_{o ∈ O} ( {Prob}_{o} * {Sim}_{o , c} ) \qquad ( Eq . 7 )$$

where O is the set of observed items having c in their top-K. Thus, cold-start item scores will be proportional to their most similar observed item probability scores.

With continued reference to FIG. 4, the next document prediction module 108 may include a pooling operation 406, described above with respect to FIG. 3, in which vector representations of individual documents are combined into a representation of a session including a sequence of those documents (e.g., a session encoding 408). The next document prediction module 108 may further include a fully convolutional network 410 that receives a session encoding as input and outputs one or more predicted next documents, along with a respective probability, for each of those predicted next documents, that the document is the correct predictions. The output may be in the form of, or may be used to generate, a ranked list 412 of predicted next documents, ranked by probability.

FIG. 5 is a diagrammatic view of a method 500 for determining a predicted next user action. The method 500 may be implemented with the system 100, in some embodiments.

Given the final session representation of session S (this final representation is shown in FIG. 5 and referenced below as z_{final}), a next document in S may be predicted by first performing category predictions of the next document and using the category prediction results to predict a next document. Specifically, we first obtain T-level category prediction results (e.g., {p₁, . . . , p_{T}}) of the next item using z_{final} from the session encoder at 502 according to equation (8) below:

pₜ=FC_{C}_{ₜ}(z_{final})∈R^{|C}^{ₜ}^{|},∀t,1≤t≤T (Eq. 8)

The category prediction vectors {p₁, . . . , p_{T}} may be transformed to category prediction embeddings {E₁^{P}, . . . , E_{T}^{P}} 506 via projection layers (Projₜ∈R^{|C}^{ₜ}^{|×}^{_{d}}^{P} at 504 according to equation (9) below:

E_{T}^{P}=Projₜ(pₜ)∈R^{d}^{_{P}},∀t,1≤t≤T (Eq. 9)

The session representation z_{final} and the summation of category prediction embeddings {E₁^{P}, . . . , E_{T}^{P}} may be concatenated at 508 and input to a fully-connected layer at 510 to generate a next-item prediction vector pₙₑₓₜ∈R|I| according to equation (10) below:

pₙₑₓₜ=FCₙₑₓₜ(concat(z_{final},Σₜ₌₁^{T}Eₜ^{P} (Eq. 10)

The above process may be used to predict multiple categories, and loss functions of each category prediction and the final item/document prediction may be combined and jointly optimized together. In some embodiments, cross-entropy loss functions for both category and item predictions. Assuming the ground-truth categories of a next-item iₖ₊₁ are c₁, . . . , c_{T}, then a loss function of a level-t category prediction task may be given in equation (11) below:

L_{C}_{ₜ}(pₜ)=Σᵢ₌₁^{|C}^{ₜ}^{|}yₜ(i)log(Softmax(pₜ)ᵢ) (Eq. 11)

where yₜ is a one-hot vector whose Cₜth value is 1, pₜ is a level-t category prediction score vector, and

$${Softmax ( x )}_{i} = \frac{{e}^{{x}_{i}}}{{\sum }_{j} {e}^{{x}_{j}}} .$$

Similarly, the next-item prediction loss may be given in equation (12) below:

Lₙₑₓₜ(pₙₑₓₜ)=−Σᵢ₌₁^{|I|}yₜ(i)log(Softmax(pₙₑₓₜ)ᵢ) (Eq. 12)

where y is a one-hot vector whose iₖ₊₁th value is 1, and pₙₑₓₜ is a next-item prediction score vector.

The combined loss function for multi-task learning may be given in equation (13) below:

L_{final}=Lₙₑₓₜ+λΣᵢ₌₁^{T}L_{C}_{ₜ} (Eq. 13)

where λ is a weighting value for category prediction tasks. The value of 2 may be selected experimentally, for example.

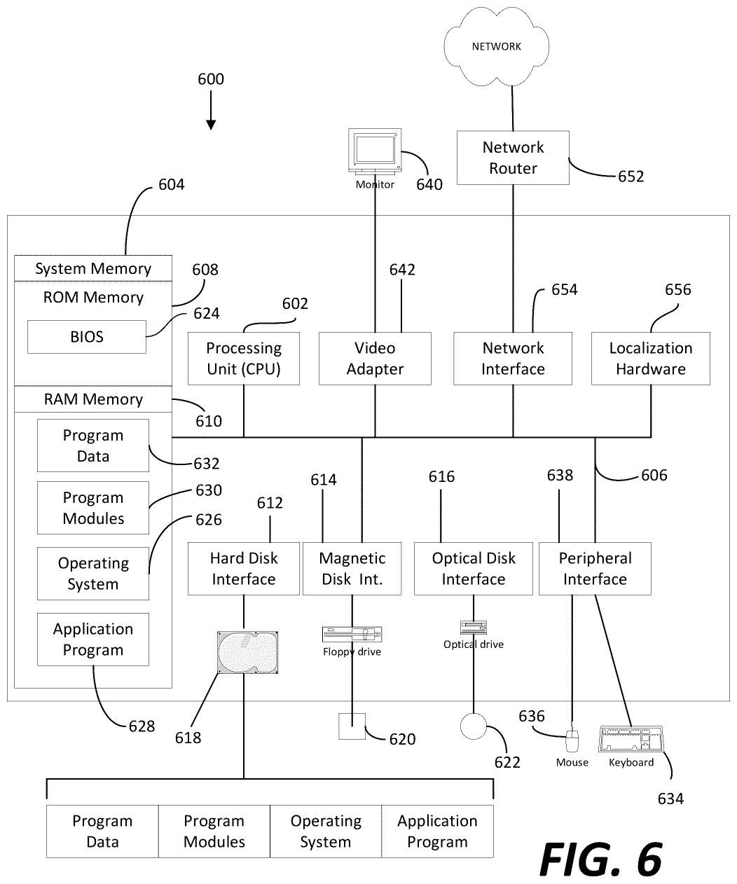

FIG. 6 is a diagrammatic view of an example embodiment of a user computing environment that includes a general purpose computing system environment 600, such as a desktop computer, laptop, smartphone, tablet, or any other such device having the ability to execute instructions, such as those stored within a non-transient, computer-readable medium. Furthermore, while described and illustrated in the context of a single computing system 600, those skilled in the art will also appreciate that the various tasks described hereinafter may be practiced in a distributed environment having multiple computing systems 600 linked via a local or wide-area network in which the executable instructions may be associated with and/or executed by one or more of multiple computing systems 600.

In its most basic configuration, computing system environment 600 typically includes at least one processing unit 602 and at least one memory 604, which may be linked via a bus 606. Depending on the exact configuration and type of computing system environment, memory 604 may be volatile (such as RAM 610), non-volatile (such as ROM 608, flash memory, etc.) or some combination of the two. Computing system environment 600 may have additional features and/or functionality. For example, computing system environment 600 may also include additional storage (removable and/or non-removable) including, but not limited to, magnetic or optical disks, tape drives and/or flash drives. Such additional memory devices may be made accessible to the computing system environment 600 by means of, for example, a hard disk drive interface 612, a magnetic disk drive interface 614, and/or an optical disk drive interface 616. As will be understood, these devices, which would be linked to the system bus 606, respectively, allow for reading from and writing to a hard disk 618, reading from or writing to a removable magnetic disk 620, and/or for reading from or writing to a removable optical disk 622, such as a CD/DVD ROM or other optical media. The drive interfaces and their associated computer-readable media allow for the nonvolatile storage of computer readable instructions, data structures, program modules and other data for the computing system environment 600. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 600.

A number of program modules may be stored in one or more of the memory/media devices. For example, a basic input/output system (BIOS) 624, containing the basic routines that help to transfer information between elements within the computing system environment 600, such as during start-up, may be stored in ROM 608. Similarly, RAM 610, hard drive 618, and/or peripheral memory devices may be used to store computer executable instructions comprising an operating system 626, one or more applications programs 628 (which may include the functionality of the category prediction system 104 of FIG. 1 or one or more of its functional modules 106, 108, 110, for example), other program modules 630, and/or program data 632. Still further, computer-executable instructions may be downloaded to the computing environment 600 as needed, for example, via a network connection.

An end-user may enter commands and information into the computing system environment 600 through input devices such as a keyboard 634 and/or a pointing device 636. While not illustrated, other input devices may include a microphone, a joystick, a game pad, a scanner, etc. These and other input devices would typically be connected to the processing unit 602 by means of a peripheral interface 638 which, in turn, would be coupled to bus 606. Input devices may be directly or indirectly connected to processor 602 via interfaces such as, for example, a parallel port, game port, firewire, or a universal serial bus (USB). To view information from the computing system environment 600, a monitor 640 or other type of display device may also be connected to bus 606 via an interface, such as via video adapter 632. In addition to the monitor 640, the computing system environment 600 may also include other peripheral output devices, not shown, such as speakers and printers.

The computing system environment 600 may also utilize logical connections to one or more computing system environments. Communications between the computing system environment 600 and the remote computing system environment may be exchanged via a further processing device, such a network router 652, that is responsible for network routing. Communications with the network router 652 may be performed via a network interface component 654. Thus, within such a networked environment, e.g., the Internet, World Wide Web, LAN, or other like type of wired or wireless network, it will be appreciated that program modules depicted relative to the computing system environment 600, or portions thereof, may be stored in the memory storage device(s) of the computing system environment 600.

The computing system environment 600 may also include localization hardware 656 for determining a location of the computing system environment 600. In embodiments, the localization hardware 656 may include, for example only, a GPS antenna, an RFID chip or reader, a WiFi antenna, or other computing hardware that may be used to capture or transmit signals that may be used to determine the location of the computing system environment 600.

The computing environment 600, or portions thereof, may comprise one or more components of the system 100 of FIG. 1, in embodiments.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A method for predicting a next user selection in an electronic user interface, the method comprising:
receiving, from a user, a sequence of selections of documents;
generating, for each document in the sequence, a respective attribute vector, the attribute vector comprising:
a numerical attribute vector portion representative of numerical attributes of the document;
a category attribute vector portion representative of category information of the document;
a text content vector portion representative of text content of the document; and
an image content vector portion representative of one or more images in the document;
inputting the attribute vectors of the sequence into a machine learning model; and
outputting, to the user, in response to the sequence of selections, a predicted next document selection according to an output of the machine learning model.

2. The method of claim 1, wherein the attribute vector respective of each document does not include any portion representative of a unique identifier of that document.

3. The method of claim 1, further comprising:
combining the respective attribute vectors of the sequence to generate a single sequence vector;
wherein inputting the attribute vectors of the sequence into the machine learning model comprises inputting the single sequence vector into the machine learning model.

4. The method of claim 1, further comprising:
training the machine learning model according to a training data set, the training data set comprising:
a plurality of attribute vectors representative of a plurality of user document selection sequences, each attribute vector comprising:
one or more numerical attribute vector portions representative of numerical attributes of one or more documents in one of the sequences;
one or more category attribute vector portions representative of category information of one or more documents in one of the sequences; and
one or more text content vector portions representative of text content of one or more documents in one of the sequences.
one or more image vector portions representative of one or more images in one or more documents in one of the sequences.

5. The method of claim 1, wherein outputting the predicted next document selection comprises one or more of:
displaying a link to the predicted next document in response to a user search;
displaying a link to the predicted next document in response to a user navigation; or
displaying a link to the predicted next document in response to a user click.

6. The method of claim 1, wherein the output of the machine learning model comprises a respective unique identifier of one or more predicted next documents.

7. The method of claim 6, wherein the output of the machine learning model further comprises a respective category of one or more predicted next documents.

8. The method of claim 7, wherein the respective categories of the one or more predicted next documents is used by the machine learning model to generate the respective unique identifiers of the one or more predicted next documents.

9. The method of claim 1, wherein the respective attribute vector for each document in the sequence comprises a unique identifier portion representative of a unique identifier of the document.

10. A system for predicting a next user selection in an electronic user interface, system comprising:
a processor; and
a non-transitory, computer-readable memory storing instructions that, when executed by the processor, cause the system to perform operations comprising:
receiving, from a user, a sequence of selections of documents;
generating, for each document in the sequence, a respective attribute vector, the attribute vector comprising:
a numerical attribute vector portion representative of numerical attributes of the document;
a category attribute vector portion representative of category information of the document; and
a text content vector portion representative of text content of the document;
an image vector portion representative of one or more images in the document;
inputting the attribute vectors of the sequence into a machine learning model; and
outputting, to the user, in response to the sequence of selections, a predicted next document selection according to an output of the machine learning model.

11. The system of claim 10, wherein the attribute vector respective of each document does not include any portion representative of a unique identifier of that document.

12. The system of claim 10, wherein the memory stores further instructions that, when executed by the processor, cause the system to perform further operations comprising:
combining the respective attribute vectors of the sequence to generate a single sequence vector;
wherein inputting the attribute vectors of the sequence into the machine learning model comprises inputting the single sequence vector into the machine learning model.

13. The system of claim 10, wherein the memory stores further instructions that, when executed by the processor, cause the system to perform further operations comprising:
training the machine learning model according to a training data set, the training data set comprising:
a plurality of attribute vectors representative of a plurality of user document selection sequences, each attribute vector comprising:
one or more numerical attribute vector portions representative of numerical attributes of one or more documents in one of the sequences;
one or more category attribute vector portions representative of category information of one or more documents in one of the sequences; and
one or more text content vector portions representative of text content of one or more documents in one of the sequences.
one or more image vector portions representative of one or more images in one or more documents in one of the sequences.

14. The system of claim 10, wherein outputting the predicted next document selection comprises one or more of:
displaying a link to the predicted next document in response to a user search;
displaying a link to the predicted next document in response to a user navigation; or
displaying a link to the predicted next document in response to a user click.

15. The system of claim 10, wherein the output of the machine learning model comprises a respective unique identifier of one or more predicted next documents.

16. The system of claim 15, wherein the output of the machine learning model further comprises a respective category of one or more predicted next documents.

17. The system of claim 16, wherein the respective categories of the one or more predicted next documents is used by the machine learning model to generate the respective unique identifiers of the one or more predicted next documents.

18. The system of claim 10, wherein the respective attribute vector for each document in the sequence comprises a unique identifier portion representative of a unique identifier of the document.

19. A method comprising:
receiving, from a user, a sequence of selections of documents;
generating, for each document in the sequence, a respective attribute vector according to metadata respective of the document, but not according to a unique identifier of the document;
inputting the attribute vectors of the sequence into a machine learning model; and
outputting, to the user, in response to the sequence of selections, a predicted next document selection according to an output of the machine learning model.

20. The method of claim 19, wherein generating a respective attribute vector for each document in the sequence is further according to a content of the document.
